(19) United States
(12) Patent Application Publication
(10) Pub. No.: US 2025/0067317 A1
(43) Pub. Date: Feb. 27, 2025

(54) HYDRAULIC COMPRESSION STOP WITH NECKED-DOWN CYLINDER TUBE

(71) Applicant: BeijingWest Industries Co., Ltd., Beijing (CN)

(72) Inventors: Michal Jerzy POPIELARZ, Krakow (PL); Dominik KASPRZYK, Debica (PL)

(21) Appl. No.: 18/766,662

(22) Filed: Jul. 9, 2024

(30) Foreign Application Priority Data
Aug. 25, 2023 (CN) 202311083781.0

(51) Int. Cl. F16F 9/49; F16F 9/18; F16F 9/34

(52) U.S. Cl. CPC F16F 9/49; F16F 9/18; F16F 9/34

(57) ABSTRACT

A damper assembly includes a main tube filled with a working liquid; a piston assembly connected to a rod and slidably disposed within the main tube. The piston assembly divides an interior of the main tube into a rebound chamber and a compression chamber. A hydraulic compression stop (HCS) assembly includes a piston sleeve disposed in the compression chamber and attached to the piston assembly. The main tube includes a shoulder and a necked-down portion extending from the shoulder and having a reduced diameter smaller than a diameter of the main tube opposite of the shoulder. The necked-down portion is configured to receive the piston sleeve. A tubular wall is disposed around the necked-down portion and defines an external flow channel outside of the main tube. The necked-down portion defines a plurality of axially-spaced holes each providing fluid communication between the compression chamber and the external flow channel.

### CROSS-REFERENCE TO RELATED APPLICATIONS

This application claims priority to Chinese Patent Application No. 202311083781.0, filed on Aug. 25, 2023, which is hereby incorporated by reference in its entirety.

### BACKGROUND OF THE INVENTION

### 1. Field of the Invention

The present invention generally relates to a damper assembly for a vehicle.

### 2. Description of the Prior Art

Damper assemblies are well known in the art for use in a vehicle. US2001025753 discloses a damper assembly comprising a cylinder in which a piston rod is mounted in an axially adjustable fashion. A piston is connected to an end of the piston rod within the cylinder and separates a compression chamber from a rebound chamber. A rebound stop assembly which includes a rebound spring is disposed in the rebound chamber. Documents US2018355944, DE102015119731 and DE1430494 disclose damper assemblies provided with various end of stroke stop assemblies comprising compressible spring arrangements coupled with pistons.

As a compression stop assembly requires space for operation, it is common to provide this space by decreasing a so-called minimum bearing span of a damper, that is the distance between a rebound stop and a main piston assembly. This in turn restricts implementation of the damper in suspension systems with a piston rod that is subjected to side loads (e.g. MacPherson struts), where a sufficient bearing span is crucial for proper operation of the damper. It is thus desirable to reduce the working length of a compression stop assembly. Reduced working length of a compression stop assembly is also beneficial in terms of packaging and handling the dampers.

It is an object of the present disclosure to provide a hydraulic damper with a compression stop assembly, having a reduced operational length when compared with alternative designs, which is cost efficient and simple in manufacture and assembly, and which provides versatile tuning properties for shaping the additional damping force.

### SUMMARY OF THE INVENTION

The present invention provides a damper assembly. The damper assembly includes a main tube filled with a working liquid; a rod disposed at least partially within the main tube, and a piston assembly connected to the rod and slidably disposed within the main tube. The piston assembly divides an interior of the main tube into a rebound chamber and a compression chamber. The damper assembly also includes a hydraulic compression stop assembly including a piston sleeve disposed in the compression chamber and attached to the piston assembly. The main tube includes a shoulder and a necked-down portion extending from the shoulder and having a reduced diameter smaller than a diameter of the main tube opposite of the shoulder, wherein the necked-down portion is configured to receive the piston sleeve. A tubular wall is disposed around the necked-down portion and defining an external flow channel outside of the main tube. The necked-down portion defines a plurality of axially-spaced holes, each providing fluid communication between the compression chamber and the external flow channel.

The present disclosure also provides a hydraulic compression stop assembly for a damper. The hydraulic compression stop assembly includes a piston sleeve having a tubular shape attached to a piston; a main tube defining a compression chamber and including a shoulder and a necked-down portion extending from the shoulder and having a reduced diameter smaller than a diameter of the main tube opposite of the shoulder, wherein the necked-down portion is configured to receive the piston sleeve; and a tubular wall disposed around the necked-down portion and defining an external flow channel outside of the main tube. The necked-down portion defines a plurality of axially-spaced holes each providing fluid communication between an interior of the necked-down portion and the external flow channel.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 shows a fragmentary view of a vehicle suspension including the damper assembly in accordance with the present invention;

FIG. 2 shows a cross-sectional fragmentary view of the damper assembly;

FIG. 3 shows a perspective cut-away view of an adapter, according to an aspect of the present disclosure;

FIG. 4 shows a cross-sectional fragmentary view of the damper assembly illustrating flow therethrough during a compression stroke, and with an enlarged fragmentary view showing details of the hydraulic compression stop assembly; and

### DESCRIPTION OF THE ENABLING EMBODIMENT

Referring to the Figures, wherein like numerals indicate corresponding parts throughout the several views, it is one aspect of the present invention to provide a damper assembly 20 for a vehicle 10. The damper assembly 20 includes a hydraulic compression stop (HCS) assembly 70.

The damper assembly 20 of the present disclosure, including HCS assembly 70 provides several advantages over alternative designs. It provides for a simplified construction with lower complexity and higher-precision of components with lower variation in manufacturing tolerances. It is also less temperature sensitive than alternative designs.

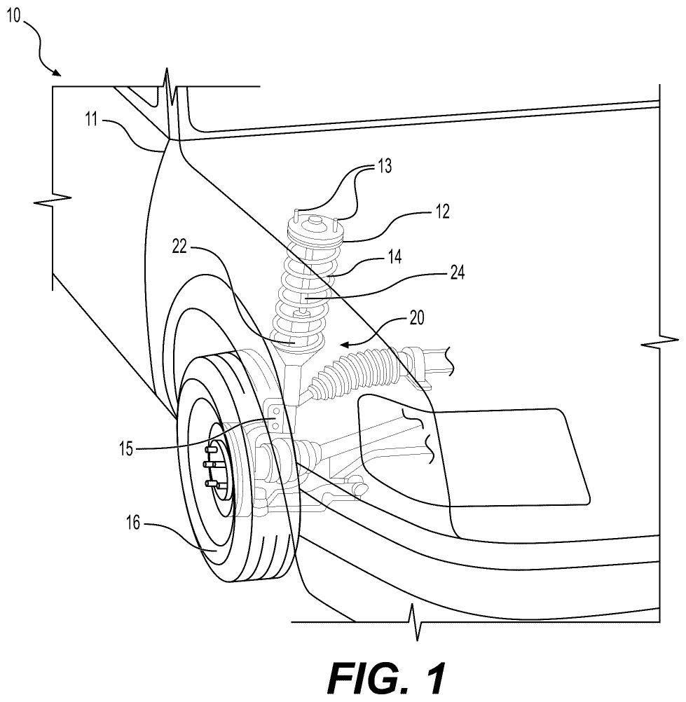

A generally illustrated in FIG. 1, the damper assembly 20 is attached to a chassis 11 of the vehicle 10 by a top mount 12. A number of screws 13 extend through an upper surface of the top mount 12 to fasten the top mount 12 to a body of the vehicle 10. The top mount 12 is connected to a coil spring 14 and a rod 24 of the damper assembly 20. The damper assembly 20 is also connected to a knuckle 15 supporting a wheel 16 of the vehicle 10. The damper assembly 20 of the present disclosure may be used in other configurations and/or orientations.

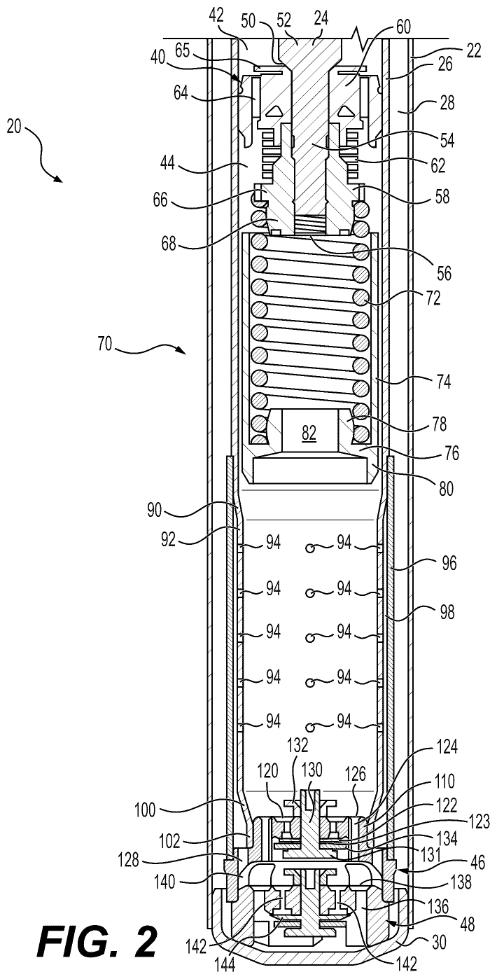

As generally shown in FIG. 2, the damper assembly 20 includes an outer tube 22 and a main tube 26 each having a tubular shape, and with the outer tube 22 disposed annularly about the main tube and 26 defining a compensation chamber 28 therebetween. The main tube 26 may be filled with a working liquid, such as an oil. The damper assembly 20 also includes a rod 24 that is disposed, at least partially, within the main tube 26. The rod 24 protrudes out of an open end of the outer tube (not shown in FIG. 2). A piston assembly 40 is connected to the rod 24 and is slidably disposed within the main tube 26. The piston assembly divides an interior of the main tube 26 into a rebound chamber 42 and a compression chamber 44. An end cap 30 encloses a lower end of the outer tube 22, opposite from the open end through which the rod 24 extends.

The rod 24 includes a taper 50 from a main portion 52 to an end portion 54, with the end portion 54 having a smaller diameter than the main portion 52 and extending between the taper 50 to a terminal end 56 of the rod 24, located within the main tube 26.

The piston assembly 40 includes a lower body 58 and an upper body 60, each disposed about the end portion 54 of the rod 24, with the lower body 58 being adjacent to the terminal end 56, and with the upper body 60 being located adjacent to the taper 50. A piston spring 62, which may include one or more wave springs, is disposed between the upper body 60 and the lower body 58.

The piston assembly 40 includes one or more piston valves 64, 65 configured to regulate a flow of the working liquid between the rebound chamber 42 and the compression chamber 44 and to thereby generate a damping force. For example, and as shown on FIG. 2, the upper body 60 defines a plurality of piston passages 64 extending therethrough and providing fluid communication between the rebound chamber 42 and the compression chamber 44. One or more piston discs 65 covers the piston passages 64 and is configured to regulate a flow of the working liquid through the plurality of piston passages 64 and to thereby generate the damping force. The piston discs 65 are shown covering an end of the piston passages 64 at the rebound chamber 42, thereby generating the damping force in a compression direction. However, this is merely an example, and the piston assembly 40 may include other configurations of piston passages 64 and/or piston discs 65 to generate a damping force in either or both of a compression and/or a rebound direction.

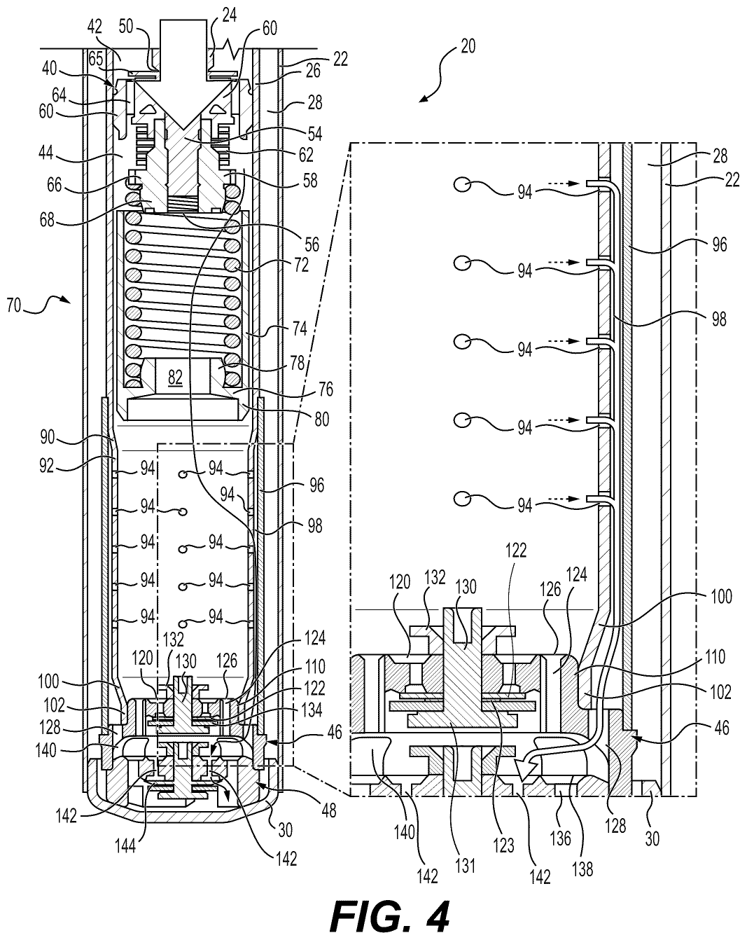

The lower body 58 includes a flange portion 66 and a first tubular portion 68 that extends from the flange portion 66 away from the upper body 60 extending annularly about the end portion 54 of the rod 24. The flange portion 66 and the first tubular portion 68 together define a spring retainer for receiving and holding a spring 72. The spring 72 is disposed between and attached to each of the lower body 58 of the piston assembly 40 and the piston sleeve 74, and allows the piston sleeve 74 to move in an axial direction and relative to the piston assembly 40. The spring 72 may include a coil spring, as shown in FIGS. 2 and 4. However, other types of springs, such as a wave spring, or a bellows-type, may be used for attaching the piston assembly 40 to the piston sleeve 74, while allowing some relative motion therebetween.

In some embodiments, the spring 72 may be integrally formed with the piston sleeve 74. For example, the spring 72 and the piston sleeve 74 may be integrally formed of a molded plastic material. In such an arrangement, not shown in the FIGs, the spring 72 may have a bellows-type construction.

The HCS assembly 70 includes the coil spring 72 and the piston sleeve 74, each disposed in the compression chamber 44. The piston sleeve 74 has a tubular shape and is attached to the lower body 58 of the piston assembly 40. Alternatively, the piston sleeve 74 may be attached to another component of the piston assembly 40, such as a mounting stud or a nut that is separate from the lower body 58. The coil spring 72 connects the piston sleeve to the lower body 58 of the piston assembly 40 and is disposed, at least partially, within an interior of the piston sleeve 74. The piston sleeve 74 may be made of plastic, such as polyamide.

The piston sleeve 74 also includes a partially-closed wall 76 that extends radially inwardly from an inner surface adjacent to a lower end, opposite from the piston assembly 40. A second tubular portion 78 extends from the partially-closed wall 76 within the piston sleeve 74 and in an axial direction toward the piston assembly 40. The partially-closed wall 76 and the second tubular portion 78 together define a second spring retainer for receiving and holding an end of the coil spring 72. A tubular protrusion 80 extends in an axial direction from the partially-closed wall 76, opposite from the piston assembly 40. The partially-closed wall 76 and the second tubular portion 78 together define a center bore 82, providing fluid flow though the piston sleeve 74.

The main tube 26 includes a first shoulder 90 and a necked-down portion 92 that extends from the first shoulder 90, away from the rebound chamber 42 and having a reduced diameter that is smaller than a diameter of the main tube 26 at an opposite side of the first shoulder 90. The HCS assembly 70 includes the necked-down portion 92, which is configured to receive the piston sleeve 74 in a loose-fitting relationship with a relatively small gap therebetween to minimize uncontrolled oil flow therebetween.

The HCS assembly 70 also includes a tubular wall 96 disposed annularly around the necked-down portion 92 and defining an external flow channel 98 outside of the main tube 26. The necked-down portion defines a plurality of axially-spaced holes 94 each providing fluid communication between the compression chamber 44 and the external flow channel 98. The plurality of axially-spaced holes 94 includes a second plurality of the axially-spaced holes 94, arranged in multiple sets circumferentially spaced apart from one another. The multiple sets may include sets of the axially-spaced holes 94 spaced apart at 90-degree intervals, as shown in FIG. 2. However, the HCS assembly 70 may include a different number and/or a different configuration of the sets of the axially-spaced holes 94.

In operation, and adjacent to an end of a compression stroke of the damper assembly 20, the piston sleeve 74 enters into the necked-down portion 92 and progressively covers more and more of the axially-spaced holes 94, thereby generating a corresponding increase in compression damping force.

The damper assembly 20 also includes an adapter 46 and a base valve assembly 48, each disposed within the outer tube 22 and adjacent to the end cap 30. The adapter 46 is fixed to the base valve assembly 48 and is configured to regulate fluid flow between the compression chamber and the base valve assembly 48. The base valve assembly 48 is configured to control a flow of the working liquid between the compression chamber 44 and the compensation chamber 28, and to thereby generate a damping force.

The main tube 26 includes a second shoulder 100 and defines tubular end portion 102 that extends from the second shoulder 100, away from the rebound chamber 42 and having a reduced diameter that is smaller than a diameter of the necked-down portion 92. The adapter 46 includes a valve body 110 that fits within the tubular end portion 102, enclosing the lower end of the main tube 26.

The adapter 46 includes a compression safety valve 120, 122 configured to open at a predefined threshold of pressure within the compression chamber 44 and to allow the working liquid to flow out of the compression chamber 44 and to bypass the plurality of axially-spaced holes 94 and the external flow channel 98. The compression safety valve 120, 122 includes a safety valve passage 120 defined by the valve body 110 and extending between the compression chamber 44 at a lower end of the necked-down portion 92, and an intermediate chamber 140 that extends between the adapter 46 and the base valve assembly 48. The compression safety valve 120, 122 includes a safety valve disc stack 122 having one or more discs covering an end of the safety valve passage 120 opposite from the compression chamber.

The valve body 110 defines a plurality of flow passages 128 each configured to provide fluid communication between the external flow channel 98 and the base valve assembly 48 via the intermediate chamber 140.

The adapter 46 also includes a stem 130 that extends in an axial direction through a center of the valve body 110. The stem 130 includes a flange portion 131 adjacent a lower end of the valve body 110, within the intermediate chamber 140. A stem retainer 132, such as a nut or a crimped ring, extends around an upper end of the stem 130, within the compression chamber 44 for holding the stem 130 with the valve body 110. A washer 134 of resilient material is disposed annularly about the stem 130, between the flange portion 131 and the valve body 110. A disc spacer 123 is disposed annularly about the stem 130, between the washer 134 and the valve body 110. The safety valve disc stack 122 is disposed annularly about the stem 130, between the disc spacer 123 and the valve body 110. However, the configuration of the compression safety valve 120, 122 including, e.g. order, number, and/or type of components, may be different from those shown in the illustrated embodiment.

The adapter 46 also includes a rebound check valve 124, 126 configured to allow fluid flow from the base valve assembly 48, via the intermediate chamber 140, and into compression chamber 44, thereby bypassing the external flow channel 98 during a rebound stroke of the damper assembly 20, while blocking fluid flow in an opposite direction. The rebound check valve 124, 126 includes a rebound passage 124 defined by the valve body 110 and extending between the compression chamber 44 at a lower end of the necked-down portion 92, and the intermediate chamber 140. The rebound check valve 124, 126 also includes a check valve disc 126 that covers an end of the rebound passage 124 at the compression chamber 44 and configured to deflect away from the rebound passage 124 to allow the working liquid to flow from the rebound passage 124 into the compression chamber 44, while blocking a flow of the working liquid in an opposite direction.

The base valve assembly 48 includes a rebound valve assembly 136, 138 configured as a check valve to allow fluid flow from the compensation chamber 28 and into the intermediate chamber 140 during a rebound stroke of the damper assembly 20, while blocking fluid flow in an opposite direction. For example, and as shown on FIG. 2, base valve assembly 48 defines a plurality of base valve rebound passages 136 extending therethrough and providing fluid communication between the compensation chamber 28 and the intermediate chamber 140. One or more first base valve discs 138 covers the base valve rebound passages 136 and are configured to allow fluid flow from the compensation chamber 28, through the base valve rebound passages 136, and into the intermediate chamber 140, while blocking fluid flow in an opposite direction.

The base valve assembly 48 also includes a compression valve assembly 142, 144 configured to generate a damping force during a compression stroke of the damper assembly 20. For example, and as shown on FIG. 2, base valve assembly 48 defines a plurality of base valve compression passages 142 extending therethrough and providing fluid communication between the compensation chamber 28 and the intermediate chamber 140. One or more second base valve discs 144 covers the base valve compression passages 142 and are configured to restrict fluid flow from the intermediate chamber 140, through the base valve compression passages 142, and into the compensation chamber 28, while also blocking fluid flow in an opposite direction.

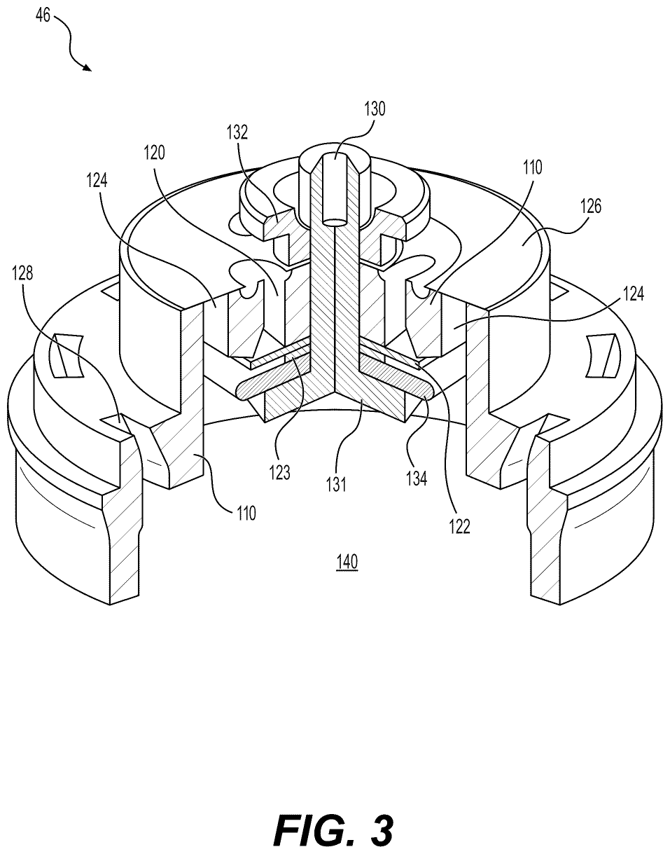

FIG. 3 shows a perspective cut-away view of the adapter 46, and FIG. 4 shows a cross-sectional fragmentary view of the damper assembly 20, illustrating flow therethrough during a compression stroke, with an enlarged fragmentary view showing details of the necked-down portion 92 and the adapter 46.

As shown in FIG. 4, during a compression stroke, the working liquid is directed through the center bore 82 of the piston sleeve 74, and out of the main tube 26 via the axially-spaced holes 94. As the piston sleeve 74 enters the necked-down portion 92 of the main tube 26, it progressively covers more and more of the axially-spaced holes 94, increasing damping force.

The HCS assembly 70 of the present disclosure provides for operating characteristic can be divided into two stages. The first stage corresponds to a stroke of the piston sleeve 74, and the second stage corresponds to when safety valve is activated. The HCS assembly 70 includes several parameters that can be adjusted for tuning operating characteristics. Parameters for tuning the first stage include: attack length, progressive stroke length, and progression of force increase. Attack length, which may also be called a position of engagement point may be defined by a sum lengths of: the coil spring 72, necked-down portion 92, and the piston sleeve 74. The attack length may be tuned by varying a length of the coil spring 72, a length of the piston sleeve 74 that extends away from the piston assembly 40 and beyond the coil spring 72, and an axial length of the necked-down portion 92, and/or a position of the axially-spaced holes 94.

The progressive stroke length may be defined by a length of the necked-down portion 92 and/or a distribution of the axially-spaced holes 94. For example, the axially-spaced holes 94 may be located along half of the necked-down portion 92, and the progressive stroke length would correspond to half of the necked-down portion 92. The progressive stroke length may be tuned by adjusting the length of the necked-down portion 92. The Progression of force increase may be adjusted by one or more of a diameter, number and position of the axially-spaced holes 94. In some embodiments, the axially-spaced holes 94 may have different diameters as along a length of the necked-down portion 92.

Tuning of the second stage can be performed similarly to a conventional disc valve member, by varying one or more of number, thickness, diameter, and/or preload of deflective discs within the safety valve disc stack 122, thickness of a spacer and/or size or quantity of the safety valve passages 120.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility.

What is claimed is:

1. A damper assembly comprising:
a main tube filled with a working liquid;
a rod disposed at least partially within the main tube;
a piston assembly connected to the rod and slidably disposed within the main tube, the piston assembly dividing an interior of the main tube into a rebound chamber and a compression chamber;
a hydraulic compression stop assembly including a piston sleeve disposed in the compression chamber and attached to the piston assembly;
the main tube including a shoulder and a necked-down portion extending from the shoulder and having a reduced diameter smaller than a diameter of the main tube opposite of the shoulder, wherein the necked-down portion is configured to receive the piston sleeve; and
a tubular wall disposed around the necked-down portion and defining an external flow channel outside of the main tube; and
wherein the necked-down portion defines a plurality of axially-spaced holes, each providing fluid communication between the compression chamber and the external flow channel.

2. The damper assembly of claim 1, further comprising a base valve assembly located at a closed end of the main tube and configured to control a flow of the working liquid between the compression chamber and a compensation chamber.

3. The damper assembly of claim 2, wherein the base valve assembly includes a compression valve assembly and a rebound valve assembly each configured to control the flow of the working liquid between the compression chamber and the compensation chamber.

4. The damper assembly of claim 2, further comprising an outer tube disposed annularly about the main tube and defining the compensation chamber therebetween.

5. The damper assembly of claim 2, further comprising a rebound check valve configured to allow fluid flow from the base valve assembly and into the compression chamber while blocking fluid flow in an opposite direction, thereby bypassing the external flow channel during a rebound stroke.

6. The damper assembly of claim 1, further including a spring disposed between and attached to each of the piston sleeve and the piston assembly, thereby allowing the piston sleeve to move in an axial direction and relative to the piston assembly.

7. The damper assembly of claim 6, wherein the piston sleeve includes a tubular portion defining a spring retainer configured to hold an end of the spring opposite from the piston assembly.

8. The damper assembly of claim 6, wherein the spring includes a coil spring.

9. The damper assembly of claim 6, wherein the spring is at least partially disposed within the piston sleeve.

10. The damper assembly of claim 6, wherein the spring is integrally formed with the piston sleeve.

11. The damper assembly of claim 6, wherein the spring and the piston sleeve are formed of a plastic material.

12. The damper assembly of claim 1, wherein the plurality of axially-spaced holes includes a second plurality of holes circumferentially spaced apart from one another.

13. The damper assembly of claim 1, further comprising a compression safety valve configured to open at a predefined threshold of pressure within the compression chamber and to allow the working liquid to flow out of the compression chamber and to bypass the plurality of axially-spaced holes and the external flow channel.

14. The damper assembly of claim 2, further comprising an adapter fixed to the base valve assembly and configured to regulate fluid flow between the compression chamber and the base valve assembly.

15. The damper assembly of claim 14, wherein the adapter defines a plurality of flow passages providing fluid communication between the external flow channel and the base valve assembly.

16. The damper assembly of claim 14, wherein the adapter encloses a bottom end of the main tube adjacent to the base valve assembly; and
wherein the adapter includes a rebound check valve configured to allow fluid flow from the base valve assembly and into the compression chamber while blocking fluid flow in an opposite direction, thereby bypassing the external flow channel during a rebound stroke.

17. The damper assembly of claim 1, wherein the piston assembly further includes at least one valve assembly configured to regulate a flow of the working liquid between the rebound chamber and the compression chamber and to thereby generate a damping force.

18. A hydraulic compression stop assembly for a damper, comprising:
a piston sleeve having a tubular shape attached to a piston;
a main tube defining a compression chamber and including a shoulder and a necked-down portion extending from the shoulder and having a reduced diameter smaller than a diameter of the main tube opposite of the shoulder, wherein the necked-down portion is configured to receive the piston sleeve; and
a tubular wall disposed around the necked-down portion and defining an external flow channel outside of the main tube; and
wherein the necked-down portion defines a plurality of axially-spaced holes each providing fluid communication between an interior of the necked-down portion and the external flow channel.

19. The hydraulic compression stop assembly of claim 18, further comprising an adapter at least partially enclosing an end of the necked-down portion and configured to regulate fluid flow therethrough.

20. The hydraulic compression stop assembly of claim 19, wherein the adapter includes a rebound check valve configured to allow fluid flow into the compression chamber while blocking fluid flow in an opposite direction, thereby bypassing the external flow channel during a rebound stroke.
